(19) United States
(12) Patent Application Publication
(10) Pub. No.: US 2019/0030646 A1
(43) Pub. Date: Jan. 31, 2019

(54) Device And Method For Reducing A Stress Concentration At An Edge Of A Laminated Composite Material

(71) Applicant: Airbus Operations GmbH, Hamburg (DE)

(72) Inventors: Albrecht Kluge, Hamburg (DE); Peter Linde, Hamburg (DE)

(73) Assignee: Airbus Operations GmbH, Hamburg (DE)

(21) Appl. No.: 16/044,841

(22) Filed: Jul. 25, 2018

(30) Foreign Application Priority Data
Jul. 31, 2017 (DE) 10 2017 117 325.0

(51) Int. Cl. B23K 26/36; G02B 6/42; B23K 26/00; B23K 26/064; B23K 26/08; B32B 3/02; B32B 27/08; B32B 7/04; B32B 3/26

(52) U.S. Cl. CPC B23K 26/36; G02B 6/4296; B23K 26/0006; B23K 26/064; B32B 3/263; B32B 3/02; B32B 27/08; B32B 7/045; B23K 26/0869

(57) ABSTRACT

A device for reducing a stress concentration at an edge of a laminated composite material has an optical element, an actuator element, and a receptacle space for a first component of a laminated composite material which can be or is connected to a second component via a contact face and has an edge element above the contact face. The optical element defines a focus face for laser radiation for vaporizing laminated composite material. The actuator element is designed to move the optical element around a first component arranged in the receptacle space. and orients the optical element in such a way that an angle, including the first component, between the contact face and the focus face is smaller than 90°. The angle is selected such that after vaporization of the laminated composite material at the focus face the stress concentration at the edge element is reduced under load.

### FIELD OF THE INVENTION

The invention relates to a device for reducing a stress concentration at an edge of a laminated composite material.

### BACKGROUND OF THE INVENTION

Discrete attachment elements such as e.g. rivets or continuous attachment methods such as, for example, vulcanising, bonding or—in the case of thermoplastics—welding are used to connect light composite structures. The two composite structures to be connected are usually made to overlap and the attachment is formed at the overlapping region. It is insignificant here whether the two composite structures to be connected are connected to one another during the manufacture of a shell or in order to connect “doublers” in the case of a repair.

At the edges of the faces of the composite structures which overlap one another, the composite stress is very high in the case of shearing movements, i.e. when the composite structures in one direction are subjected to forces in parallel with the common contact face. Stress concentrations then occur at the connection. These stress concentrations result in the connection having stress peaks at the edges of the composite structures in the overlapping region.

### BRIEF SUMMARY OF THE INVENTION

An aspect of the invention may make available a device and a method which avoids stress peaks at the edges of composite structures in overlapping regions.

According to an embodiment of the invention, a device for reducing a stress concentration at an edge of a laminated composite material is provided, wherein the device has an optical element, an actuator element, and a receptacle space for a first component composed of a laminated composite material, wherein the first component can be or is connected to a second component via a contact face and has an edge element above the contact face, wherein the optical element defines a focus face for laser radiation for vaporizing laminated composite material, wherein the actuator element is designed to move the optical element around a first component which is arranged in the receptacle space, wherein the actuator element orients the optical element with an edge element in such a way that an angle, including the first component, between the contact face and the focus face is smaller than 90°, wherein the angle is selected such that after vaporization of the laminated composite material at the focus face the stress concentration at the edge element is reduced under load.

With the device according to an embodiment of the invention it is possible to shape edges of composite components composed of composite material in which the stress concentrations which build up during shearing movements are reduced. A first component or a composite component, which has a first component and a second component which are connected to one another via a contact face, is arranged in the receptacle space of the device. As a rule, at least one of the two components has a step-shaped edge which is arranged on the edge element, on the contact face between the two components.

An optical element which defines a focus face for laser radiation is oriented with an actuator element in such a way that the focus face is arranged at an oblique angle with respect to the step-shaped edge. By directing laser light through the optical element, the laser light is concentrated on the focus face and vaporizes the composite material. In this context, a ramp is produced which replaces the step-shaped edge, wherein the step-shaped edge has an angle of 90° with respect to the second component, and the ramp has an angle which is less than 90° when the angle between the contact face and the ramp within the first component is measured. That is to say the surface of the first component leads to the surface of the second component via a smooth ramp.

Owing to the reshaping of the step-shaped edge into a ramp, a stress concentration at the edge element of the first component in the overlapping range with the second component is avoided. The reduction of the stress concentration has the effect that the connection between the components is subjected to less stress and therefore becomes more durable and more stable. Furthermore, the vaporization of the composite material brings about a reduction in the weight of the material. This is advantageous in particular in the case of aircraft construction in which as much weight as possible is intended to be saved. Furthermore, the mass of the component can also be reduced beforehand, since by reducing the stress concentration it is possible to use relatively small and relatively thin components. The requirements which are made of the components can therefore be optimized. It is therefore possible to achieve a further reduction in the weight.

The actuator element is advantageously a robot arm. With a robot arm it is possible to position the optical element flexibly in all three spatial directions.

The optical element advantageously has the focus face for radiation of a high-energy laser system. With a high-energy laser system it is possible to vaporize composite material quickly and easily. As a result of the rapid vaporization it is possible to manufacture the shape and the angle of the ramp very quickly. Furthermore, the rapid vaporization of the composite material allows the surface of the ramp to be made very smooth without residues from melting processes, which can arise during slow melting, remaining on the ramp.

It is advantageous here if the optical element is connected to the high-energy laser system by means of an optical fibre, wherein the optical fibre guides the laser light emitted by the high-energy laser system to the optical element. By means of the optical fibre, the optical path of the laser light is adapted automatically to the optical element during the movement of the optical element. Re-adjustment of the laser system during movement of the optical element is therefore avoided.

The device expediently has a control unit which transmits control signals to the actuator element. The actuator element can therefore be controlled automatically on a predefined path with the control unit. The predefined path can be transmitted into the control unit by means of programming.

According to an aspect of the invention, furthermore a method for reducing a stress concentration at an edge of a laminated composite material is provided, wherein the method has the following steps: a) making available a first component made of laminated composite material which can be or is connected to a second component via a contact face, wherein the first component has an edge element above the contact face, b) moving an optical element with an actuator element with respect to the edge element, with the result that the edge element is arranged in a focus face of the optical element, c) orienting the optical element by means of the actuator element, with the result that an angle, including the first component, between the contact face and the focus face is less than 90°, d) eroding the composite material, arranged in the focus face, of the edge element by means of laser radiation directed through the optical element, wherein the angle is selected such that after step d) a stress concentration under load at the edge element is less than before step d).

The method can be applied both to a single first component and to a first component which is connected to a second component. Therefore, it is possible to use the method to optimize small components with respect to the stress distribution even before these small components are connected to a large component. The ease of handling of the method is improved by virtue of the fact that method steps which require movement or repositioning of a large component can be avoided.

In the text which follows, the method has the same advantages and effects as the device. Therefore, in order to avoid repetitions, reference is made to the description specified above.

The method advantageously comprises the step: e) moving the optical element by means of the actuator element along the edge element while step d) is being executed.

The edge element can therefore be processed with laser radiation focused by the optical element, in one continuous working step, i.e. can be reworked from a step-shaped edge to a ramp.

The method expediently has, before step c), the step: f) determining the angle by means of a simulation of the stress concentration at the first component.

By means of the determination of the angle with a simulation it is possible to detect the optimum angle before the reworking of the first component. This avoids a situation in which different angles have to be tested in order to obtain optimum stress distribution at the edge element of the first component. The manufacturing process can therefore be sped up significantly. Furthermore, this makes it possible to avoid a situation in which stress concentrations can occur despite the reworking of the edge element.

In another exemplary embodiment, the stress concentration can be detected by means of a laser measurement, and the precise predefined angle which brings about a reduction in the stress concentration can subsequently be determined.

Furthermore, a composite component is provided which is manufactured by means of the method according to the preceding description, wherein the composite component comprises: a first component which comprises a laminated composite material with at least one layer; wherein the first component can be connected to the second component via a contact face, wherein the first component has an edge element above the contact face, wherein the edge element comprises a surface element which forms, with respect to the contact face, an angle, including the first component, of less than 90° wherein at least one layer has a layer surface element which is oriented in parallel with the surface element, and wherein the layer surface element adjoins at least one other layer of the first component and forms at least part of the surface element.

The advantages and effects of the composite component are apparent from the description cited above. In order to avoid repetitions, reference is therefore made to the description specified above.

The surface element is advantageously planar. The surface element forms here a smooth surface, even though the fundamental composite material is constructed from a plurality of layers and the angle which the surface element forms with the contact face within the first component is less than 90°.

The surface element therefore does not have a step so that the ramp, produced by the method, on the edge element results in a planar surface which extends over the individual layers of the composite structure from the contact face as far as the surface of the first component. Each edge of the individual layers therefore has an edge face which forms part of the face element and which has an included angle with respect to at least one other face of less than 90°. This at least one other face is the face which points towards the contact face of the first component. In the case of the lowest layer which adjoins the second component, the other face is identical to the contact face.

The composite component advantageously has a second component which is connected to the first component via the contact face.

### BRIEF DESCRIPTION OF THE DRAWINGS

In the text which follows, the invention will be described on the basis of an exemplary embodiment by means of the appended drawing, in which:

FIG. 1 shows a schematic illustration of the device during the processing of an edge element of a stringer;

FIG. 2 shows a schematic illustration of an overlapping region of a first component with a second component, wherein the first component is embodied as a stringer;

FIG. 3 shows a schematic cross-sectional illustration of an overlapping region of two components and the stress concentration therein;

FIGS. 4a and 4b show a schematic cross-sectional illustration of a device with an overlapping region of two components and the stress concentration therein; and

FIG. 5 shows a schematic illustration of a flowchart of the method.

### DETAILED DESCRIPTION

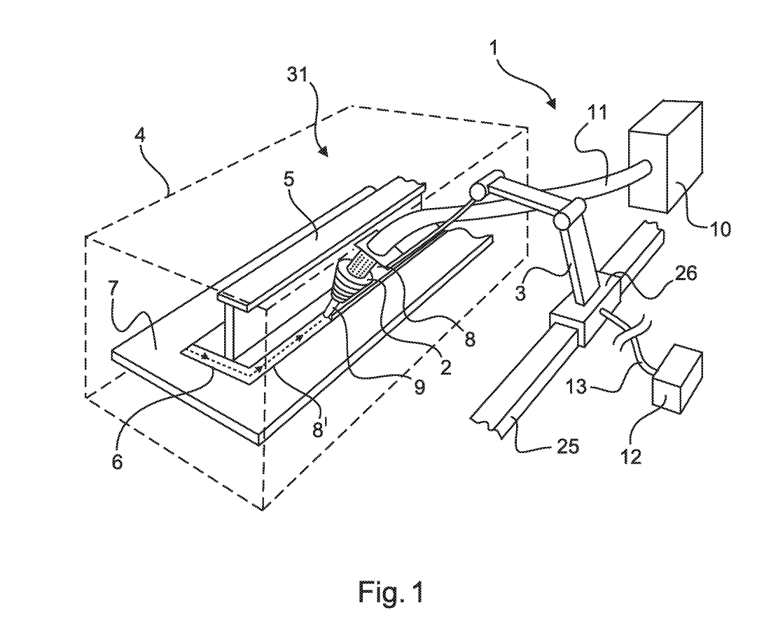

The device is referred to below in its entirety by the reference symbol 1, as illustrated in FIG. 1. The device 1 comprises an optical element 2, an actuator element 3, a receptacle space 4, a high-energy laser system 10 and a control device 12.

The optical system 2 is connected to the actuator element 3. The actuator element 3 can be embodied here as a robot arm. With the actuator element 3 it is possible to position the optical element 2 at a wide variety of locations in each orientation.

The optical element 2 furthermore defines a focus face 9 in which laser light, which is directed through the optical element 2, is focussed. The laser light is generated here in the high-energy laser system 10 and directed to the optical element 2 by means of an optical fibre 11 which connects the high-energy laser system 10 to the optical element 2.

The focus face 9 defines, through the focussing of the laser light, a face in which high temperatures occur if laser light is guided through the optical element 2. A composite material can be vaporized on the focus face 9 by means of the high temperatures. In this context, the composite material is vaporized in the region of the focus face 9, and a face is produced in the composite material which is parallel to the focus face 9. The angle of the focus face 9 therefore also determines the angle of the resulting surface which remains after the vaporization of the composite material.

A first component 5, which is embodied as a stringer in this exemplary embodiment, is illustrated in FIG. 1 here. The first component 5 is connected to a second component 7 via a contact face 6. The contact face 6 is arranged between the first component 5 and the second component 7 here. The first component 5 has an edge element 8, 8′ above the contact face 6. Part of the edge face of the edge element, said part denoted by the reference number 8′, is embodied as a ramp. Another part, denoted by the reference number 8, has a stepped shape. The focus face 9 of the optical element 2 is arranged between the edge element regions 8 and 8′ in FIG. 1. The focus face 9 vaporizes part of the edge element region 8 in FIG. 1 and converts this region 8 into a surface element 30 which has, with the contact face 6, an angle of less than 90° which includes the first component 5. This angle, which the surface element 30 has at the edge element 8′, corresponds to the angle which the focus face forms with the contact face 6.

The optical element 2 is moved along the edge element 8 by means of the actuator element 3. For this purpose, the actuator element 3 has, in this exemplary embodiment, a rail element 25 on which a movement element 26 is arranged. The movement element 26 can move along the rail 25 independently.

In an alternative embodiment, the actuator element 3 can be arranged above or below the receptacle space 4 (not illustrated). In this context, the actuator element 3 can be mounted rotatably, with the result that the optical element 2 can be made to approach the first component 5 from all sides and can be oriented therewith.

In a further alternative embodiment, the actuator element 3 can be arranged on a mobile platform (not illustrated), wherein the mobile platform can be moved independently of the receptacle space 4. In this way, the optical element 2 can be arranged flexibly with respect to the first component 5.

The actuator element 3 can be controlled by means of the control unit 12 via a signal cable 13. For this purpose, the control unit 12 can be designed to receive a predefined angle for the optical element 2 with respect to the first component 5. This predefined angle can be determined e.g. from a simulation of the voltage profile at the first component 5. Furthermore, the control element 12 can output a triggering signal for the high-energy laser system 10.

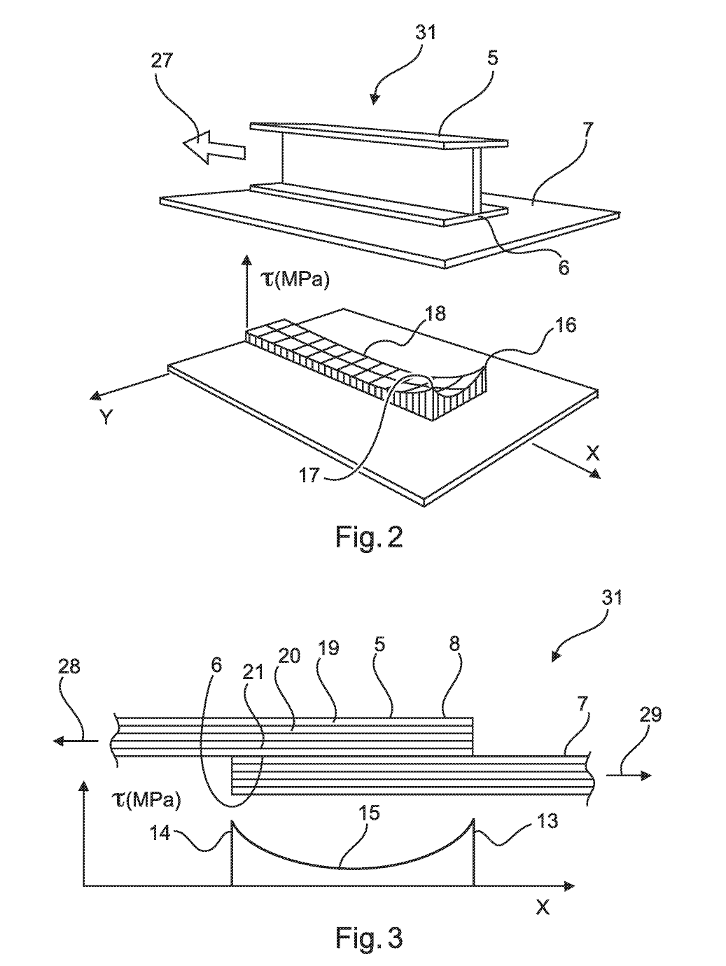

An example of the simulation of a stress concentration distribution at the first component 5 is illustrated in FIG. 2. The arrow 27 shows here a shearing movement which acts on the first component 5. Since the first component 5 is connected to the second component 7 via the contact face 6, stresses arise between the first component 5 and the second component 7. This stress is plotted in the lower region of FIG. 2. In this context, the X axis and Y axis are the surface coordinates of the contact face and the vertical axis is the magnitude of the stress t at a specific point on the surface. The plane 18 indicates here the magnitude of the stress concentration of the surface. Significant increases in stress can be seen at the ends 16 and 17 in FIG. 2. The surface 18 runs here in a curved fashion, with the result that a high stress concentration is present particularly at the edge regions and corner regions of the first component 5.

This high stress concentration can cause individual layers of the composite material from which the first component can be formed to become detached, as a result of which the connection between the first component 5 and the second component 7 is weakened. The entire composite component therefore becomes weaker.

An example of the connection between a first component 5, which is illustrated as a shell component or as a “doubler”, and a second component 7 is illustrated in FIG. 3. The contact face 6 is arranged here between the first component 5 and the second component 7. The arrows 28 and 29 show here tensile forces which are arranged parallel with respect to the contact face 6. The resulting stress between the two components is illustrated in the diagram arranged under the components. Just one dimension is illustrated in FIG. 3 here. The stress curve 15 is increased here at the ends 13 and 14 of the two components. The stresses between the two components drop away abruptly outside the contact face 6.

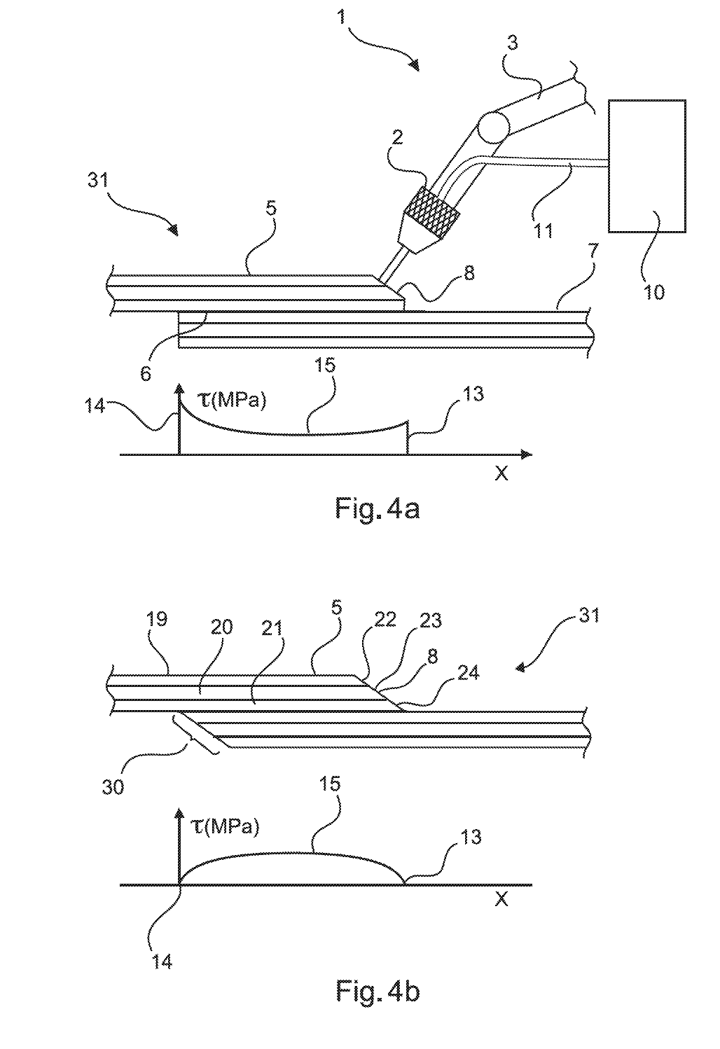

FIG. 4a illustrates how an edge element 8 is processed from an optical element 2 by means of laser radiation by means of a device 1 according to the invention. The edge element 8 is partially converted into a ramp shape here. This is apparent from the stress diagram arranged underneath the second component 7. The stress concentration at the end 13 of the stress curve 15 is lower than the stress concentration at the end 14. Since the processing of the edge element 8 is not yet concluded, the stress concentration at the end 13 is still higher than at the minimum value of the curve 15.

FIG. 4b shows a composite material 31 which has surface elements 30 at the edge elements 8. The surface elements 30 are planar. That is to say the laminate layers 19, 20, 21 of the first component 5 have layer end faces 22, 23, 24 which are planar and which together form the surface element 30. The layer end faces 22, 23, 24 therefore have the same angle with respect to the contact face 6 as the surface element 30. The stress diagram which is arranged underneath the second component 7 is a stress curve 15 which has an extremely low stress concentration at the ends 13 and 14. Stress peaks are no longer present.

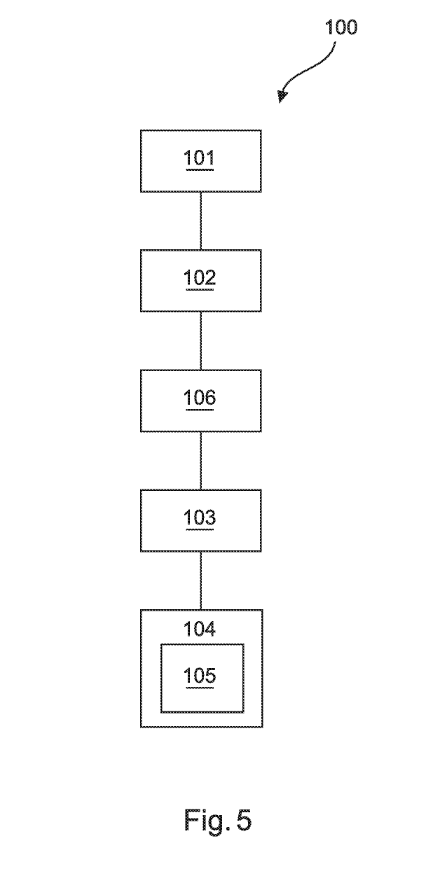

FIG. 5 shows a diagram of a method 100 according to the invention. In a first step 101, a first component composed of laminated composite material is made available here. The first component is connected to a second component via a contact face here and has an edge element above the contact face. The first component can be made available here in a receptacle space of a device according to the invention.

In a second step 102, an optical element is moved with respect to the edge element. The movement of the optical element can be carried out here with an actuator element. Furthermore, the edge element is arranged, by virtue of the movement of the optical element, into a focus face which is defined by the optical element. In this way, laser radiation which is directed through the optical element can impinge on the focus face. As a result, composite material on the edge element can be vaporized.

In a further step 106, a simulation can be used to calculate an angle for the edge element on the first component, which angle brings about a reduction in the stress concentration at the edge element of the first component in comparison with the original angle at the edge element. This angle can accordingly also be referred to as an angle of change. Furthermore, this angle is a predefined angle.

The angle has here a value between 0° and 90° and is measured in such a way that it includes the first component and is determined between a surface element of the processed edge element and the contact face.

The optical element can be oriented in step 103 by means of the actuator element in such a way that the focus face assumes the predefined angle in comparison with the contact face.

Then, in a step 104 the composite material of the edge element which is arranged in the focus face can be eroded. The erosion is carried out by introducing laser radiation into the optical element. The laser radiation is focused in the focus face by means of the optical element. A high temperature is therefore suddenly generated in the focus face by means of the laser radiation. The composite material is vaporized by this high temperature. In this way, a surface element can be generated which is planar over the laminated layers of the composite material and forms, with the contact face, an angle which is less than 90°. This face is furthermore smooth and runs continuously between the surface of the first component pointing away from the contact face and the surface of the second component adjoining the contact face.

While the step 104 is being carried out, the optical element can be moved along the edge element with the actuator element with a step 105. The optical element can therefore be moved along the edge element, with the result that the focus face is also moved along the edge element. In this way, a face on the edge element can be processed which is larger than the focus face. The processing can take place without interruption.

Furthermore, the angle of the optical element can be varied during the movement along the edge element, in order to obtain a minimum stress concentration at each position of the edge element.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for reducing a stress concentration at an edge of a laminated composite material, wherein the device comprises:
an optical element;
an actuator element; and
a receptacle space for a first component composed of a laminated composite material, wherein the first component can be or is connected to a second component via a contact face and has an edge element above the contact face,
wherein the optical element defines a focus face for laser radiation for vaporizing laminated composite material,
wherein the actuator element is configured to move the optical element around a first component arranged in the receptacle space,
wherein the actuator element orients the optical element with an edge element in such a way that an angle, including the first component, between the contact face and the focus face is smaller than 90°, and
wherein the angle is selected such that after vaporization of the laminated composite material at the focus face the stress concentration at the edge element is reduced under load.

2. The device according to claim 1, wherein the actuator element is a robot arm.

3. The device according to claim 1, wherein the optical element has the focus face for radiation of a high-energy laser system.

4. The device according to claim 3, wherein the optical element is connected to the high-energy laser system by an optical fibre, and
wherein the optical fibre guides the laser light emitted by the high-energy laser system to the optical element.

5. The device according to claim 1, wherein the device comprises a control unit configured for transmitting control signals to the actuator element.

6. A method for reducing a stress concentration at an edge of a laminated composite material, wherein the method comprises:
a) providing a first component made of laminated composite material which can be or is connected to a second component via a contact face, wherein the first component has an edge element above the contact face,
b) moving an optical element with an actuator element with respect to the edge element, with the result that the edge element is arranged in a focus face of the optical element,
c) orienting the optical element by the actuator element, with the result that an angle, including the first component, between the contact face and the focus face, is less than 90°,
d) eroding the composite material, arranged in the focus face, of the edge element by laser radiation directed through the optical element,
wherein the angle is selected such that after step d) a stress concentration under load at the edge element is less than before step d).

7. The method according to claim 6, wherein the method further comprises:
e) moving the optical element by the actuator element along the edge element while step d) is being executed.

8. The method according to claim 6, wherein the method comprises, before step c):
f) determining the angle by a simulation of the stress concentration at the first component.

9. A composite component manufactured by the method according to claim 6, wherein the composite component comprises:
a first component which comprises a laminated composite material with at least one layer;
wherein the first component can be connected to a second component via a contact face,
wherein the first component has an edge element above the contact face,
wherein the edge element comprises a surface element which forms, with respect to the contact face, an angle, including the first component, of less than 90°,
wherein at least one layer has a layer surface element which is oriented in parallel with the surface element, and
wherein the layer surface element adjoins at least one other layer of the first component and forms at least part of the surface element.

10. The composite component according to claim 9, wherein the surface element is planar.

11. The composite component according to claim 9, wherein the composite component has a second component which is connected to the first component via the contact face.
